(19) United States
(12) Patent Application Publication
(10) Pub. No.: US 2007/0073977 A1
(43) Pub. Date: Mar. 29, 2007

(54) Early global observation point for a uniprocessor system

(76) Inventors: Robert J. Safranek, Portland, OR (US); Robert Greiner, Beaverton, OR (US); David L. Hill, Cornelius, OR (US); Buderya S. Acharya, El Dorado Hills, CA (US); Zohar Bogin, Folsom, CA (US); Derek Bachand, Portland, OR (US); Robert Beers, Beaverton, OR (US)

Correspondence Address: TROP PRUNER & HU, PC, 1616 S. VOSS ROAD, SUITE 750, HOUSTON, TX, 77057-2631, US

(21) Appl. No.: 11/241,363

(22) Filed: Sep. 29, 2005

(51) Int. Cl. G06F 13/28

(52) U.S. Cl. 711/141

(57) ABSTRACT

In one embodiment, the present invention includes a method for performing an operation in a processor of a uniprocessor system, initiating a write transaction to send a result of the operation to a memory of the uniprocessor system, and issuing a global observation point for the write transaction to the processor before the result is written into the memory. In some embodiments, the global observation point may be issued earlier than if the processor were in a multiprocessor system. Other embodiments are described and claimed.

### BACKGROUND

Embodiments of the present invention relate to schemes to efficiently use processor resources, and more particularly to such schemes in a uniprocessor system.

Processor-based systems are implemented with many different types of architectures. Certain systems are implemented with an architecture based on a peer-to-peer interconnection model, and components of these systems are interconnected via point-to-point interconnects. To enable efficient operation, transactions between different components can be controlled to maintain coherency between at least certain system components.

Some processors operate according to an in-order model, while other processors operate according to an out-of-order execution model. Typically, an out-of-order processor can perform more efficiently than an in-order processor. However, even in out-of-order processors, certain transactions may still be ordered. That is, some ordering rules may dictate that certain transactions take precedence over other transactions. As a result, to maintain memory consistency and coherency, a processor or other resource may be stalled, adversely affecting performance, while waiting for other transactions to complete. This is particularly the case in systems including multiple processors such as multi-socket systems. While such ordering rules may be implemented across different types of system configurations, these rules can adversely affect performance when a system includes only limited resources, for example, a uniprocessor system, although the same consistency and coherency concerns may not exist.

Accordingly, a need exists to improve performance in a uniprocessor system.

### BRIEF DESCRIPTION OF THE DRAWINGS

FIG. 1 is a block diagram of a uniprocessor system in accordance with one embodiment of the present invention.

FIG. 2 is a block diagram of a uniprocessor system in accordance with another embodiment of the present invention.

FIG. 3 is a flow diagram of a method in accordance with one embodiment of the present invention.

FIG. 4 is a flow diagram of a method in accordance with another embodiment of the present invention.

FIG. 5 is a block diagram of a processor socket in accordance with one embodiment of the present invention.

### DETAILED DESCRIPTION

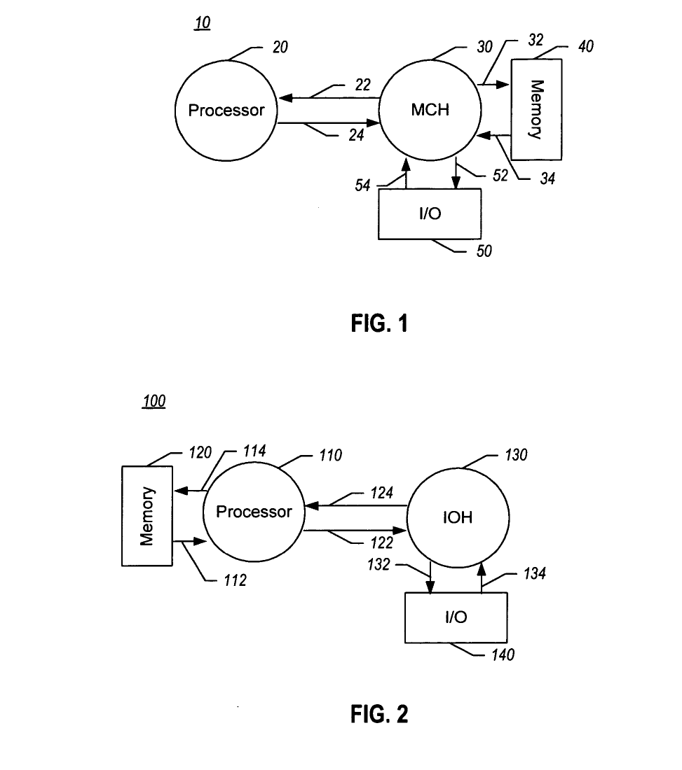

Referring now to FIG. 1, shown is a block diagram of a system in accordance with one embodiment of the present invention. Specifically, FIG. 1 shows a uniprocessor system 10. As used herein, the term “uniprocessor” refers to a system including a single processor socket. However, it is to be understood that this single processor socket may include a processor having multiple processing engines. For example, a single processor socket may include a multi-core processor, such as a chip multiprocessor (CMP). Furthermore, in some embodiments multiple processors located on different semiconductor substrates may be implemented within the single processor socket. It is further to be understood that a uniprocessor system may include multiple controllers, hubs, and other components that include processing engines to handle specific tasks for the given component.

System 10 may represent any one of a desired desktop, mobile, server or other platform, in different embodiments. In certain embodiments, interconnections between different components of FIG. 1 may be point-to-point interconnects that provide for coherent shared memory within system 10, and in one such embodiment the interconnects and protocols used to communicate therebetween may form a coherent system.

The interconnects may provide support for a plurality of virtual channels, often referred to herein as “channels” that together may form one or more virtual networks and associated buffers to communicate data, control and status information between various devices. In one particular embodiment, each interconnect may virtualize a number of channels. For example in one embodiment, a point-to-point interconnect between two devices may include up to at least six such channels, including a home (HOM) channel, a snoop (SNP) channel, a no-data response (NDR) channel, a short message (e.g., request) via a non-coherent standard (NCS) channel, data (e.g., write) via a non-coherent bypass (NCB) channel and a data response (DR) channel, although the scope of the present invention is not so limited.

In other embodiments, additional or different virtual channels may be present in a desired protocol. Further, while discussed herein as being used within a coherent system, it is to be understood that other embodiments may be implemented in a non-coherent system to provide for deadlock-free routing of transactions. In some embodiments, the channels may keep traffic separated through various layers of the system, including, for example, physical, link, and routing layers, such that there are no dependencies.

In such manner, the components of system 10 may coherently interface with each other. System 10 may operate in an out-of-order fashion. That is, all components and channels within system 10 may handle transactions in a random order. By allowing for out-of-order operation, higher performance may be attained. However, out-of-order implementation conflicts with in-order requirements occasionally required, such as for write transactions. Thus embodiments of the present invention may provide for improved handling of certain out-of-order transactions depending upon a given system configuration.

Still referring to FIG. 1, system 10 includes a processor 20 coupled to a memory controller hub (MCH) 30. Processor 20 may be a multicore processor, in some embodiments. Furthermore, processor 20, which is a complete processor socket, may include additional interfacing and other functionality. For example, in some embodiments, processor 20 may include an interface and other components such as cache memories and the like. As shown in FIG. 1, processor 20 is coupled to MCH 30 via point-to-point interconnects 22 and 24. However, in other embodiments different manners of connecting processor 20 to MCH 30 may be implemented.

As further shown in FIG. 1, MCH 30 is coupled to a memory 40 via a pair of point-to-point interconnects 32 and 34. While memory 40 may be implemented in various forms, in some embodiments memory 40 may be a dynamic random access memory (DRAM), although the scope of the present invention is not so limited. MCH 30 is further coupled to an input/output (I/O) device 50 via a pair of point-to-point interconnects 52 and 54.

It is to be understood that FIG. 1 shows one representative uniprocessor system and many other implementations may be possible. For example, in other embodiments the functionality resident in MCH 30 may be handled within a processor itself. Still further, the components shown in FIG. 1 may be coupled in different manners and via different types of interconnections.

In the embodiment of FIG. 1, at least some of the components of system 10 may collectively form a coherent system. Such a coherent system may accommodate coherent transactions without any ordering between channels through which transactions flow. While discussed herein as a coherent system, it is to be understood that both coherent and non-coherent transactions may be passed through and acted upon by components within the system. For example, a region of memory 40 may be reserved for non-coherent transactions. In some embodiments, I/O device 50 may be a non-coherent device such as a legacy peripheral component. I/O device 50 may be in accordance with one or more bus schemes. In one embodiment, I/O device 50 may be a Peripheral Component Interconnect (PCI) Express™ device, in accordance with the PCI Express Base Specification, Rev. 1.0 (Jul. 22, 2002), as an example.

While the embodiment of FIG. 1 shows a platform topology having a single processor and hub, it is to be understood that other embodiments may have different configurations. For example, a uniprocessor system may be implemented having a single processor, multiple hubs and associated I/O devices coupled thereto. Any such platform topologies may take advantage of point-to-point interconnections to provide for coherency within a coherent portion of the system, and also permit non-coherent peer-to-peer transactions between I/O devices coupled thereto. Such point-to-point interconnects may thus provide multiple paths between components.

MCH 30 may include a plurality of ports and may realize various functions using a combination of hardware, firmware and software. Such hardware, firmware, and software may be used so that MCH 30 may act as an interface between a coherent portion of the system (e.g., memory 40 and processor 20) and devices coupled thereto such as I/O device 50. In addition, MCH 30 of FIG. 1 may be used to support various bus or other communication protocols of devices coupled thereto. MCH 30 may act as an agent to provide a central connection between two or more communication links. In particular, MCH 30 may be referred to as an “agent” that provides a connection between different I/O devices coupled to system 10, although only a single I/O device is shown for purposes of illustration in FIG. 1. In various embodiments, other components within the coherent system may also act as agents. In various embodiments, each port of MCH 30 may include a plurality of channels, e.g., virtual channels that together may form one or more virtual networks.

Referring now to FIG. 2, shown is a block diagram of a uniprocessor system in accordance with another embodiment of the present invention. As shown in FIG. 2, system 100 includes a processor 110. Processor 110 is coupled to a memory 120 via a pair of point-to-point interconnects 112 and 114. In the embodiment of FIG. 2, memory controller functionality and other functionality typically present in a MCH or other memory controller circuitry instead may be implemented within processor 110. Processor 110 is coupled to an I/O hub (IOH) 130 via a pair of point-to-point interconnects 122 and 124. IOH 130 in turn is coupled to an I/O device 140 via a pair of point-to-point interconnects 132 and 134.

In certain implementations of the systems shown in FIGS. 1 and 2, a single major caching agent may be present. That is, only a single agent within systems 10 and 100 respectively, performs caching operations for the system in these implementations. Accordingly, there is no need to snoop from the single caching agent out to other agents of the systems. As a result, improved data processing may be realized, in that a reduced number of transactions may be implemented while performing desired operations.

In various embodiments, the major caching agent may be the processor socket of the system. Furthermore, to aid in effective data processing, the system may implement extensions to a coherency protocol to provide for improved handling of operations within the uniprocessor system. These protocol extensions may effectively handle conflicts within the system by providing a rule that upon a conflict between the processor and another agent of the system, the processor is allowed first access. In accordance with this rule, the processor is able to reach a global observation (GO) point early. Accordingly, the time that a processor is stalled waiting for such a GO point is minimized. In such manner, these protocol extensions for a uniprocessor coherent system thus define an in-order and early GO capability to provide optimum performance. Furthermore, the processor can operate with minimal stalls, while memory consistency and producer/consumer models remain intact. The protocol extensions may be particularly applicable to a series of write transactions from a core of a processor socket.

In various embodiments, a serialization point for transactions may be contained within a processor socket of a system. More specifically, the serialization point may be located directly after a processor pipeline. Alternately, the serialization point may be located at a last level cache (LLC) of the processor socket. As such, when the processor completes an operation, this serialization point is reached and accordingly, the processor can continue forward progress on a next operation.

A system in accordance with an embodiment of the present invention may include multiple virtual channels that couple components or agents together. In various embodiments, these virtual channels all may be implemented as ordered channels. Thus, a processor can be given an early GO point and the order of write transactions can be maintained.

If one transaction is ordered dependent on another transaction occurring in a different virtual channel, the dependent transaction may wait for completion of transaction occurring in the other channel. In such manner, ordering requirements are met. Thus, if an ordered request is dependent on a transaction in another virtual channel, the requester will complete all previously issued requests before granting a GO to a new request. That is, all previously issued requests may first receive a completion (CMP) before a new request is granted a GO signal. For example, a first core may write data along a first channel and then provide a completion indication via a second channel that the data is available (e.g., via writing to a register). Because the information in these two channels may arrive at different times, the requester may thus complete all previously issued requests before giving a GO signal to the new request. In such manner, dependencies are maintained while performance may be sacrificed. However, a second core may be unaffected by this channel change of the first core. That is, early GO signals may still be provided to transactions of the second core even if the first core is stalled pending the channel change.

Because the serialization point is located in the processor socket, an early GO point may be granted to a processor request once the request clears against any currently outstanding requests. The early global observation also indicates that the processor core takes responsibility and provides a guarantee that requests will occur in program order. That is, requests may be admitted whenever they are issued, however program order is still guaranteed. For example, when a conflict occurs, in some instances the conflict may be resolved by sleeping the second request until the first request completes.

Although an early GO signal is given to a processor, a new value of data for an address in conflict is not exposed until a completion (CMP) has occurred. For example, a tracker table may be present within a processor that includes a list of active transactions. Each active tracker entry in the table holds an address of a currently pending access. The entry is valid until after the action is completed. Accordingly, the new data value is not exposed until the active tracker entry indicates that the prior action has completed.

As described above, in various embodiments a processor may be the only major caching agent in a system. Accordingly, the processor does not need to issue any snoop requests to other agents within the system. For example, a processor socket interface does not need to snoop an I/O device, as the device is not a caching agent. By limiting snoop accesses, a minimum memory latency to the processor is provided. However, in other embodiments, other caching agents may be present within a system. In such embodiments a snoop filter may be implemented within the processor to track accesses of other agents within the system. If a snoop filter is completely inclusive, one or more other agents may act to cache data.

In various embodiments, an early GO may allow I/O agents to correctly observe the program order of writes from a given core of a processor socket via any type of read transaction (e.g., coherent or non-coherent). Via an early GO, it may also be guaranteed that the I/O agent observes the processor caching agent program order of writes and allows the writes to be pipelined. In such manner, unnecessary snoops to an I/O agent write cache may be eliminated.

Transactions from the same source that are issued in different message classes or channels may sometimes have guaranteed order. However, packets in different virtual channels cannot be considered to be in ordered channels, and thus ordering may be provided by source serialization. Accordingly, a first transaction completes before a second transaction begins, in an out-of-order implementation. However, within message classes, ordering may be guaranteed. For example, for a HOM channel, a sending agent's ordered write requests are delivered into a link layer in order of issue. Further, link/physical layers may maintain strict order of all HOM requests and snoop responses, regardless of address. Furthermore, the HOM agent commits and completes processor caching agent writes in the order received. Similar ordering requirements may be present for other channels.

In embodiments in which an integrated memory configuration is present (e.g., an embodiment such as FIG. 2) and the processor socket caching agent includes a snoop filter, I/O caching agents do not cache reads. Instead, these caching agents may invoke a use once policy, ensuring that the snoop filter is accurate for reads. In these embodiments, the snoop filter may be completely inclusive of all I/O agent's caches. Accordingly, the snoop filter may be the gating factor on determining whether to issue an early GO and not issue a snoop to an I/O agent. If an early GO is issued for a line being held in a modified (M) state, the system is no longer coherent.

In various embodiments, the processor caching agent may be the issuer of early GO signals. Accordingly, the snoop filter may be located in the processor caching agent. In some embodiments, the snoop filter may be a circular buffer with a depth equal to or greater than an I/O agent's write cache. Thus, an I/O agent may not hold more cache lines in a modified (M) state than the depth of the snoop filter. In other embodiments, a snoop filter may be located in a HOM agent, and the HOM agent updates the snoop filter based on certain requests. In still other embodiments, the snoop filter may be updated by a receiver as messages are issued out of a receive flit buffer.

When a core cacheable transaction misses in the snoop filter, an early GO is issued to the corresponding core request. Furthermore, in some embodiments the HOM agent may be notified of an implied invalid response from an I/O agent. When instead a core cacheable transaction hits in the snoop filter, a corresponding snoop is issued to the appropriate I/O agent, and an early GO is not issued to the corresponding core request.

A core can assume an exclusive (E) state ownership at the point an early GO is received for request for ownership (RFO) stores, in that an uncacheable (UC) store is guaranteed to complete and may be observed in order of program issue.

In a uniprocessor configuration, conflict resolution rules may specify that the processor agent requests always wins an E-state access on all HOM conflicts. However, the HOM agent may enforce a use-once resolution in the conflict case to regain the E-state and data before ending a transaction flow by sending a completion, giving the I/O agent final ownership.

In various embodiments, write transactions from non-processor agents to memory may be atomic. In such manner, a system may ensure that the correct memory value is written to memory. For example, with reference to system 10 of FIG. 1, a cacheable write transaction may occur to write data from I/O device 50 to memory 40. For this transaction, I/O device 50 may issue a request to obtain ownership of a cacheline to be written back. In one embodiment, a snoop invalidate instruction (i.e., SnpInvItoE) may be issued to processor 20. If this request conflicts with a current processor request, processor 20 takes precedence. Accordingly, the processor request gets the data currently contained at the desired memory location. Upon completion of the processor transaction, the write initiated by I/O device 50 may then complete. For the case of a cacheable read transaction, I/O device 50 may issue a snoop (Snp) code to processor 20. For this cacheable transaction, the processor cache state does not need to change state.

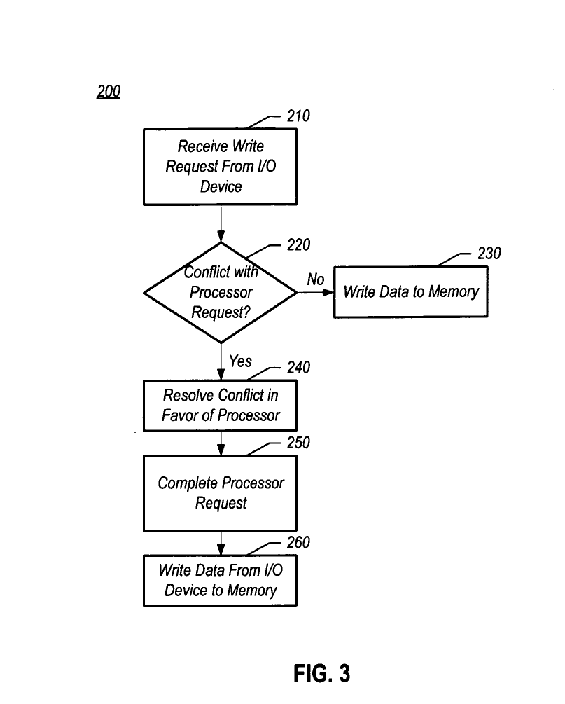

Referring now to FIG. 3, shown is a flow diagram of a method in accordance with one embodiment of the present invention. More specifically, method 200 of FIG. 3 may be used to perform a cacheable write transaction from an I/O device to memory for a uniprocessor implementation such as that shown in FIG. 1. As shown in FIG. 3, method 200 may begin by receiving a write request from an I/O device (block 210). In some embodiments, the request may be received in a controller that handles ordering of transactions and resolution of conflicts between transactions. In one embodiment, the controller may be a controller within a processor socket, although the scope of the present invention is not so limited. In some embodiments, the request may take the form of a snoop request from the I/O device to the controller.

The controller, whether implemented within the processor socket or elsewhere within a system, may include logic to handle ordering of transactions in accordance with a given protocol. For example, in one embodiment a controller may include logic to implement rules to handle ordering based upon the protocol. In addition, the controller may further include logic to handle extensions to a given protocol. For example, in various embodiments the controller may include logic to handle special rules for conflict resolution and/or to permit early GO signals within a uniprocessor system. Accordingly, when a processor socket is implemented within a system, the controller may be programmed to handle such extensions if it is implemented in a uniprocessor system. For example, during configuration of a system that includes a processor socket in accordance with an embodiment of the present invention, one or more routines within the controller may be executed to query other components of the system and perform an initialization process. Based on the results of the process, the controller may configure itself for operation in a uniprocessor or multiprocessor mode.

Still referring to FIG. 3, next it may be determined whether a conflict exists between the write request and a processor request (diamond 220). For example, the snoop request may be sent to a global queue of the processor socket to determine whether a snoop hit occurs. If no hit occurs, a snoop response to indicate a lack of conflict may be sent back to the I/O device. If no conflict exists, the desired data may be written to memory (block 230). Accordingly, in the absence of a conflict, the I/O device is permitted to write the requested data to memory unimpeded. Furthermore, in some embodiments the snoop filter may be updated to indicate the results of this write transaction.

If instead at diamond 220 it is determined that a conflict exists (e.g., by indication of a processor hit for the snoop request), control passes to block 240. There, the conflict may be resolved in favor of the processor (block 240). For example, the I/O device's request may be put to sleep until the processor transaction is completed. Then at block 250 the processor transaction may be performed and completed. After completion of the processor request, the desired I/O device transaction, namely the write transaction, may occur and the data is written from the I/O device to memory (block 260).

With reference back to system 100 of FIG. 2, a cacheable write transaction from I/O device 140 to memory 120 may also be implemented as an atomic transaction. To perform the transaction, I/O device 140 may issue an invalidate to exclusive request (InvItoE) followed by a writeback transaction (WBMtoI), in one embodiment. The one or more write transactions may be ordered. If a conflict occurs between this transaction and a processor transaction, all writes from I/O device 140 may be stalled until the conflict clears between the I/O-initiated access and processor 110. In such manner, I/O device 140 may issue the write to memory controller functionality within processor 110. In some embodiments, no more than a predetermined number of such requests may be issued. As an example, the predetermined number may correspond to the depth of the tracker table. In some embodiments, processor 110 may use tracker entries in the tracker table as a content addressable memory (CAM). If a request “hits” an entry that is active (or inactive), processor 110 may issue a snoop and not provide an early GO signal to the requesting core of processor 110. If instead no hit occurs, an early GO signal may be issued to the requesting core. In normal operation very few hits will occur and accordingly an early GO signal may be sent to the requesting core in most instances.

In the case of a cacheable read transaction, I/O device 140 may issue a read code (RdCode) to processor 110. Such a transaction does not cause a state change of a cacheline within processor 110.

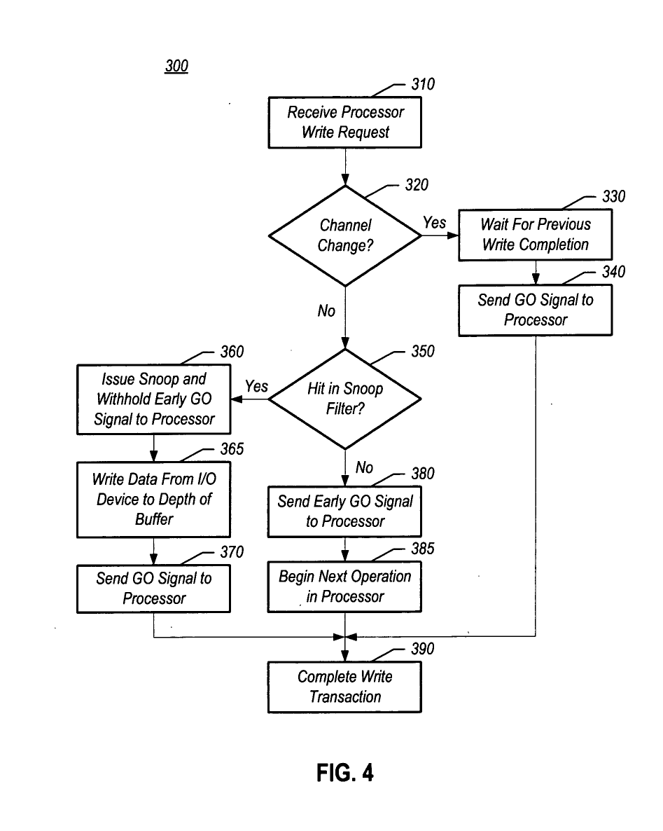

Referring now to FIG. 4, shown is a flow diagram of a method in accordance with another embodiment of the present invention. As shown in FIG. 4, method 300 may be used to handle write transactions from the processor. Method 300 may begin by receiving a processor write request (block 310). As described above, in some embodiments the request may be received in a controller that handles ordering of transactions and resolution of conflicts between different transactions. In an embodiment implemented in a uniprocessor system, such conflicts may be resolved in favor of the processor to provide an early GO signal to the processor, allowing for more efficient processor utilization.

First it may be determined whether there is a channel change (diamond 320). For example, it may be determined whether the current request is sent on the same channel as the previous transaction (e.g., a write transaction on the NCB channel). In some implementations, such cannel changes may occur infrequently. If it is determined that the channels have changed at diamond 320, this is an indication that the transaction's ordering cannot be guaranteed while providing an early GO signal. Accordingly, control passes to block 330. There, the current transaction may be held until the core's previous write completions occur (block 330). Upon such completion(s), a GO signal may be issued to the processor (block 340). Control next passes to block 390, discussed below.

If instead at diamond 320 it is determined that there is no channel change, control passes to diamond 350. It may then be determined whether there is a hit in a snoop filter (diamond 350). If so, method 300 may execute an invalidation flow in accordance with a standard protocol. That is, when a snoop hit occurs, the special rules described herein for a uniprocessor system do not apply, and standard rules for handling an invalidation flow may be performed. Accordingly, control passes to block 360. There, a snoop may be issued and an early GO signal is withheld from the processor (block 360). Next, data may be written to the depth of a buffer, such as a tracker table (block 365). Then, upon receipt of the snoop response, the GO signal may be issued to processor (block 370). Control next passes to block 390, discussed below.

If instead at diamond 350 it is determined that there is a miss in the snoop filter, control passes to block 380. There, the GO signal is sent to the processor (block 380). This GO signal, sent when there is a miss in the snoop filter, is an early GO signal as there is no need to wait for previous transactions to complete or to issue snoops to any other components within the system. Accordingly, the processor can assume that its write transaction is complete, even if the data has not been exposed. When a GO signal is issued, a next processing operation can begin (block 385). More specifically, upon receipt of a GO signal the core may issue a next dependent transaction. Furthermore, in parallel with issuance of a next dependent transaction, the prior write transaction may be completed and resources accordingly may be released (block 390). Because the program order is guaranteed for this write transaction, the actual completion of the write transaction may thus occur after the GO signal is sent.

Thus in various embodiments, because it is known that a given system is in a uniprocessor configuration and may contain only a single major caching agent, extensions to a protocol, e.g., a coherency protocol may be implemented. In such manner, the processor may perform operations more efficiently, with reduced stalls and other wait states. Furthermore, by moving the GO point as close as possible to one or more cores of the processor, such cores can have more continuous operation. That is, the cores need not wait for transactions to commit before moving onto a next operation. Instead, only if dependent or ordered writes or other such transactions occur, do one or more cores wait for a commit signal before further performing new operations.

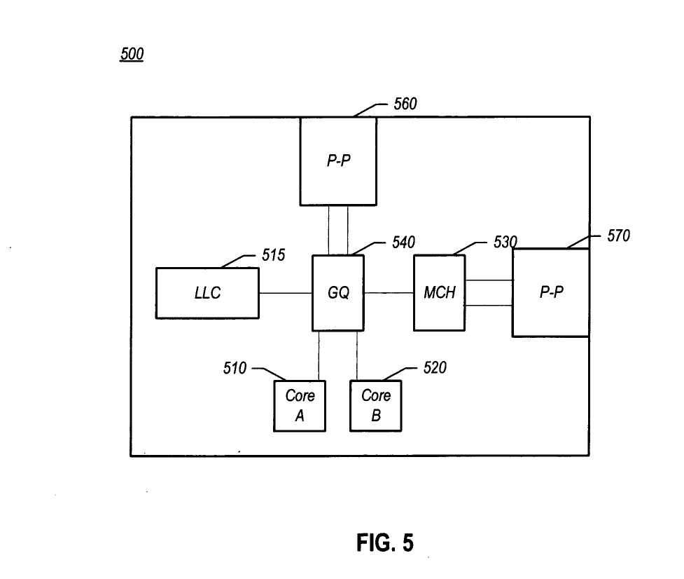

Referring now to FIG. 5, shown is a block diagram of a processor socket in accordance with one embodiment of the present invention. As shown in FIG. 5, processor socket 500 may be a multicore processor including a first core (i.e., core A) 510 and a second core (i.e., core B) 520. Each core may be coupled to a global queue (GQ) 540 which in turn is coupled to a last level cache (LLC) 515 and a memory controller hub (MCH) 530. In some embodiments, multiple cache levels may be present within processor socket 500. MCH 530 and GQ 540 may be used to implement both a snoop filter and a tracker table and to control ordering of transactions between the cores and other components coupled thereto, such as I/O devices. In some embodiments, these components may implement conflict resolution and/or early GO signal issuance as described herein if implemented in a uniprocessor system.

As further shown in FIG. 5, a plurality of point-to-point (P-P) interfaces 560 and 570 couple various components of processor socket 500 to other components of a system, such as memory, I/O controller, I/O devices and the like. While shown with two such P-P interfaces in the embodiment of FIG. 5, in other implementations a single common interface may be used to handle interfacing with various off-chip links, for example, via a switch implemented using multiplexers. While shown with this specific configuration of FIG. 5, it is to be understood that the scope of the present invention is not so limited. For example, in other embodiments additional cores may be present, such as four cores and other structures and functionality. Furthermore, components may be differently configured and different functionality may be handled by different components within a processor socket.

Embodiments may be implemented in a computer program. As such, these embodiments may be stored on a medium having stored thereon instructions which can be used to program a system to perform the embodiments. The storage medium may include, but is not limited to, any type of disk including floppy disks, optical disks, compact disk read-only memories (CD-ROMs), compact disk rewritables (CD-RWs), and magneto-optical disks, semiconductor devices such as read only memories (ROMs), random access memories (RAMs) such as dynamic RAMs (DRAMs) and static RAMs (SRAMs), erasable programmable read-only memories (EPROMs), electrically erasable programmable read-only memories (EEPROMs), flash memories, magnetic or optical cards, or any type of media suitable for storing or transmitting electronic instructions. Similarly, embodiments may be implemented as software modules executed by a programmable control device, such as a general-purpose processor or a custom designed state machine.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
performing an operation in a processor of a uniprocessor system;
initiating a write transaction to send a result of the operation to a memory of the uniprocessor system; and
issuing a global observation point for the write transaction to the processor before the result is written into the memory.

2. The method of claim 1, further comprising issuing a next dependent transaction from the processor upon receipt of the global observation point.

3. The method of claim 1, further comprising transmitting the write transaction via an ordered virtual channel comprising at least one point-to-point interconnect.

4. The method of claim 1, further comprising determining whether a conflict exists between the write transaction and another transaction, wherein the other transaction is of a non-processor of the uniprocessor system.

5. The method of claim 4, further comprising resolving the conflict by allowing the write transaction to proceed ahead of the other transaction.

6. The method of claim 1, further comprising issuing the global observation point without first snooping any agent of the uniprocessor system.

7. An apparatus comprising:
a processor core to execute instructions; and
a controller to provide a signal to the processor core when a processor transaction reaches a global observation point, wherein the controller is to generate the signal at a first time if the apparatus is located in a uniprocessor system and at a second time if the apparatus is located in a multiprocessor system, wherein the first time is earlier than the second time.

8. The apparatus of claim 7, wherein the processor core is to issue a next dependent transaction upon receipt of the signal.

9. The apparatus of claim 7, wherein the apparatus comprises a processor socket.

10. The apparatus of claim 9, wherein the processor socket comprises the single caching agent of the uniprocessor system.

11. The apparatus of claim 9, wherein the processor socket further comprises a snoop filter, and the processor socket is to determine if an entry exists in the snoop filter corresponding to an address of the processor transaction.

12. The apparatus of claim 11, wherein the controller is to withhold the signal at the first time if the entry corresponding to the address of the processor transaction is present in the snoop filter.

13. The apparatus of claim 9, wherein a serialization point for the processor transaction is within the processor socket.

14. The apparatus of claim 7, wherein the controller is to arbitrate a conflict between the processor core and a system agent.

15. The apparatus of claim 14, wherein the controller is to resolve the conflict in favor of the processor core if the apparatus is located in a uniprocessor system.

16. The apparatus of claim 7, wherein the controller is to withhold the signal until a prior request is completed if the processor transaction is dependent upon the prior request and the processor transaction and the prior request span different channels.

17. An article comprising a machine-accessible medium including instructions that when executed cause a system to:
initiate a write transaction to send a result of an operation executed in a processor core of a uniprocessor system to a memory of the uniprocessor system; and
issue a global observation point for the write transaction to the processor core before the write transaction is completed.

18. The article of claim 17, further comprising instructions that when executed cause the system to resolve a conflict between the write transaction and another transaction of a non-processor of the uniprocessor system in favor of the write transaction.

19. The article of claim 17, further comprising instructions that when executed cause the system to issue the global observation point before the write transaction is completed if an address corresponding to the write transaction misses in a snoop filter.

20. The article of claim 19, further comprising instructions that when executed cause the system to issue the global observation point after a snoop response if the address hits in the snoop filter.

21. A system comprising:
a processor socket including at least one core and a controller, the controller to issue a global observation signal to the at least one core for a core transaction upon a determination that an address corresponding to the core transaction is not present in a snoop filter; and
a dynamic random access memory (DRAM) coupled to the processor socket.

22. The system of claim 21, wherein the system comprises a uniprocessor system, the processor socket including a plurality of cores and at least one cache memory.

23. The system of claim 21, wherein the controller is to resolve a conflict between the at least one core and a system agent according to a first rule if the system is a uniprocessor system and according to a second rule if the system is a multiprocessor system.

24. The system of claim 21, wherein the controller is to issue the global observation signal at a first time if the system is a uniprocessor system and at a later time if the system is a multiprocessor system.

25. The system of claim 21, wherein the processor socket includes at least a first core and a second core, and wherein the second core is to perform transactions when a write transaction of the first core is dependent upon a channel change.
